(19) United States
(12) Patent Application Publication
(10) Pub. No.: US 2002/0131058 A1
(43) Pub. Date: Sep. 19, 2002

(54) Procedure and device for measuring the thickness of a liquid layer

(76) Inventor: Wolfgang Eberhard Luxem, Kiel (DE)

Correspondence Address: Lawrence P. Kessler, Patent Department, NexPress Solutions LLC, 1447 St. Paul Street, Rochester, NY, 14653-7103, US

(21) Appl. No.: 10/097,281

(22) Filed: Mar. 14, 2002

(30) Foreign Application Priority Data
Sep. 13, 2001 (DE) 101 45 024.9
Mar. 17, 2001 (DE) 101 13 014.7

(51) Int. Cl. G01B 11/06

(52) U.S. Cl. 356/630

(57) ABSTRACT

To determine the thickness of a liquid layer, particularly that of an oil film, on a roller in a simple manner that saves time and that is cost-effective. To achieve this task, a procedure and a device are provided in which the thickness of the liquid layer is measured by a measuring device in the printing press. In addition, a delivery device for liquid is controlled on the basis of the measured thickness of the liquid layer.

### BACKGROUND OF THE INVENTION

This invention relates to a procedure and a device for measuring the thickness of a liquid layer.

A toner material is applied to a paper sheet by an electrophoto-graphic printing press and subsequently set in the paper sheet. For this purpose, highly heated rollers are used, which grip the paper sheet from above and below to effectively set the toner material with high pressure and heat by embossing. The problem with this customary procedure is that between the heated rollers and the paper sheet stock, adhesive forces are produced, particularly with respect to the toner material, which hinder the separation of the heated rollers from the stock. As a remedy, an oil layer is applied to the heated rollers by metering and donor rollers, which ensures a loosening of the heated rollers from the stock following the setting of the toner material.

In order to avoid any adverse effects, it must be ensured that the oil layer thickness always lies within a specified range and that such thickness is neither too large nor too little. If the values of the oil layer thickness are too small, the adverse effects mentioned above occur. On the other hand, if the values of the oil layer thickness are too large, the disadvantages lie in the resulting prints being oily or too shiny, and particularly with two-sided printing, in the soiling of the printing press due to the used oil. It is thus desirable that the oil layer thickness on the heated rollers for setting the paper sheets or on setting rollers or on metering or donor rollers, which apply the oil to the heated roller, be set at a specified value.

Up until now oil layer thickness has been determined by applying the heated setting rollers, with an oil layer, on the paper sheet in the printing press for test purposes, and measuring the oil layer thickness on this paper sheet in the laboratory by a spectroscopic procedure. Apart from this costly procedure, an oiling system is set up by the operator, who uses a delivery device and metering or donor rollers to apply an oil layer based on the oil layer thickness estimated by the paper sheet and the metering or donor rollers. It is expected that an oil layer thickness in the order of several hundred nanometers delivered the best results.

### SUMMARY OF THE INVENTION

The task of the invention is to determine the thickness of a liquid layer, in particular that of an oil layer on a roller, in a simple manner that would save time and be cost-effective. To achieve this task, a procedure and a device are provided in which the thickness of a liquid layer in the printing press is measured by a measuring device. In a particularly advantageous manner, a control device to control a delivery device is provided for delivering liquid based on the calculated thickness. The rollers, as carriers of the thickness of the liquid layer to be measured, may be measured prior to the procedure according to the invention and the measuring results stored in the computer. In this manner, the unevenness of the roller surfaces, which can lead to measuring errors during the procedure according to the invention, is determined.

The thickness of the liquid layer is calculated by the measuring device as the value resulting from a variable value that is dependent on the roller surface and from the thickness of the liquid layer calculated on the basis of an even roller surface. In this connection, the measuring device may contain a rotary encoder, which calculates the rotational angle of the rollers as a function of the distances measured. Advantageously, several measuring devices may be used to increase the precision and to simultaneously measure various roller areas. These are connected to the computer and the control unit. Specific measuring points on the roller surfaces are provided, which are sufficiently smooth enough for the measurements and which have a high reflectivity, thus making measurements easier.

In a further development, the measuring device contains an interferometer, with which, for example, the thickness of the liquid layer is measured either by a change in the intensity brought about by the interference of rays of the interferometer, or by a phase difference in the rays, which depends upon the thickness of the liquid layer. When the surface of the roller is rough, the use of radiation in the infrared spectrum for measuring the thickness of the liquid layer produces particularly good results. In particular, an infrared sensor may be used.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is a schematic drawing of the side view of a roller, an oiling system, a measuring device and a computer as well as a control unit in a circuit block;

FIG. 2 is an alternate embodiment a variant of the invention with a top view of the roller similar to FIG. 1 with two measuring devices, whereby one of the measuring devices is arranged at the measuring point with a liquid layer and the other measuring device is arranged at the measuring point without a liquid layer;

FIG. 3 is a further development of the invention similar to FIG. 2 with two measuring devices, whereby one of the measuring devices determines the liquid layer thickness according to the delivery device and the second measuring device determines the oil layer thickness according to a stock;

FIG. 4 is a top view of a roller with a measuring device and the assigned measuring points in the form of strips on the roller surface; and

FIG. 5 is a view according to FIG. 4, in which the measuring points take the form of rectangles.

### DETAILED DESCRIPTION OF THE INVENTION

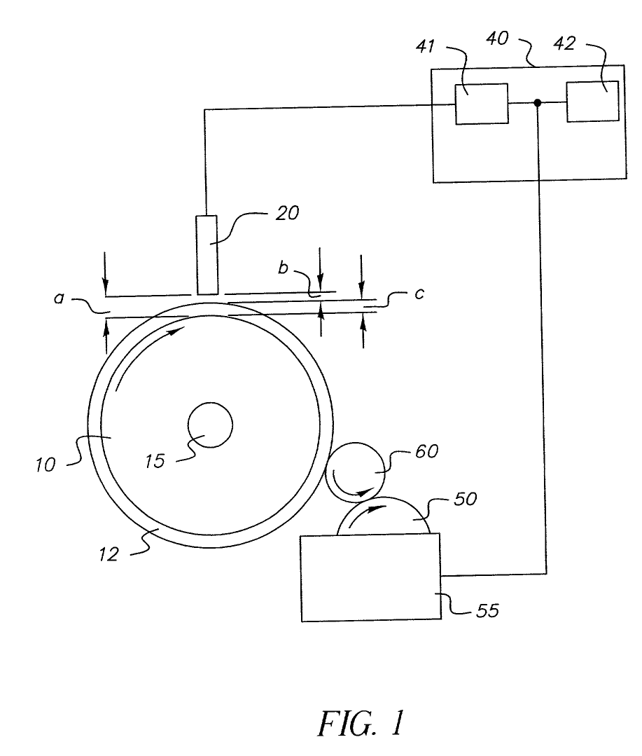

FIG. 1 illustrates a schematic drawing of a side view of a roller with an oil delivery device 55 and an oil layer thickness-measuring device 20. Computer 41 and control unit 42 are shown in a circuit block and are subsequently indicated as a combined computer and control unit 40. In the customary manner, an oil film is provided as liquid layer 12 by the delivery device 55 via a donor roller 60 and a metering roller 50 that are contained in the delivery device 55. The oil to be applied to roller 10 for setting toner material on a stock is located in a container of the delivery device 55 and is absorbed by the surface of the rubber-sheathed donor roller 60, which moves in the direction of the arrow. By contact of the metering roller 50 with the donor roller 60, the oil is rolled onto the latter. Metering roller 50, which rotates in an oil bath of delivery device 55 on a bonded fabric, moves in the direction of the arrow opposite to that of the donor roller 60 and transfers an oil film on roller 10 by contact. For clarity purposes, the oil film or the liquid layer 12 has been represented as being considerably thicker in relationship to roller 10. Another possibility of applying the oil film to roller 10 includes passing an oil-soaked cloth over roller 10.

A measuring device 20 has been arranged next to roller 10. The measuring device 20 contains a capacitive sensor that can determine the known distances on the basis of capacitive changes in the environment of its measuring transducer. Inductive or electro-optical sensors can likewise be used. Measuring device 20 is connected with a combined computer-control unit 40. In order to measure the thickness c of liquid layer 12, in this case the oil film, the electrical capacitance between a measuring transducer of the sensor and the roller surface without a liquid layer 12, represented by the line segment a, is measured with a capacitive sensor of the measuring device 20. The electrical capacitance between the roller surface and the measuring transducer is now clearly determined and is stored in the computer 41.

The next step, as described above, is to apply the liquid layer 12 of the oil film to the roller 10. The relative permittivity ε of liquid layer 12 is different from that of the roller surface, so that the measurement of the capacitive sensor now detects another capacitance between the measuring transducer of the sensor of measuring device 20 and the surface of liquid layer 12, represented by the line segment b. For example, capactitive sensors as path measuring systems achieve a dissolution of 2 nm. To strengthen the capacitance change with and without liquid and subsequently the sensor signal of the measuring device 20, an additive can be added to the oil to increase the relative permittivity ε. Based on both the above-mentioned capacitances, the value c as the thickness of the liquid layer 12 is determined in the computer-control unit 40 by comparison with the values stored therein.

In this manner, any capacitance change that is equal to the thickness of liquid layer 12 on roller 10 can be clearly assigned a length value. As can be easily understood, the length c describes the thickness of the liquid layer 12. If the thickness of liquid layer 12 does not lie in a particular desired range, the computer-control unit 40 transmits control signals to the delivery device 55. The control signals cause the amount of the liquid layer dispensed to be increased or decreased in the appropriate manner.

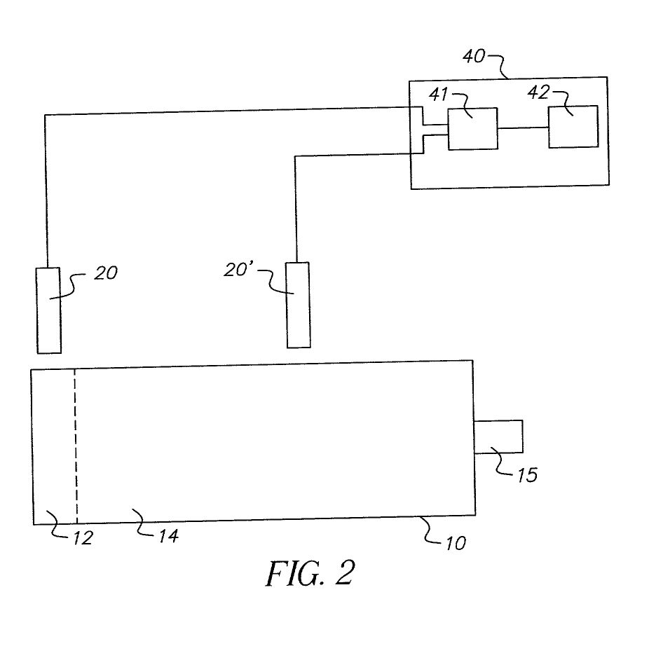

FIG. 2 indicates a schematic drawing of an alternate embodiment of the invention. Two measuring devices 20, 20′ are arranged in the vicinity of roller 10. These contain a reflectometer in this example. Reference numeral 15 shows a shaft of roller 10. The procedure performed according to FIG. 2 is similar to the procedure according to FIG. 1. In this case, contrary to the procedures in FIG. 1, the measurements of the thickness of the liquid layer 12 are not performed successively, but are instead performed simultaneously with the measuring devices 20, 20′. To this end, an area 12 of roller 10 is not supplied with liquid, in this case an oil film, while the other area 14 is supplied with liquid in the customary manner. As is evident in FIG. 2, the two areas are separated from each other by a dotted line for clarity purposes. The advantage of this modified procedure is that no measurement is required prior to the operation of roller 10 with the printing press (not shown). The measuring procedure can be fully carried out during the operation of the printing press. The computer-control unit 40 controls the delivery device 55 according to the calculated values of the oil layer thickness c. As a result, the delivery device 55 supplies a suitable amount of liquid or oil to roller 10.

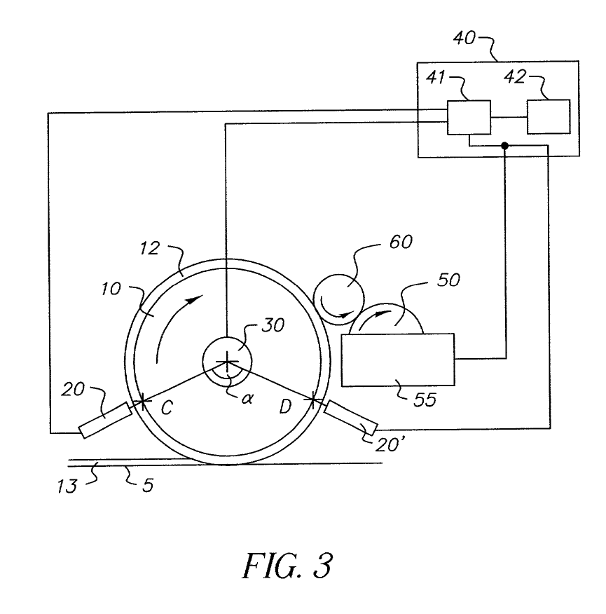

FIG. 3 shows another embodiment of the invention similar to that in FIGS. 1 and 2. Two measuring devices 20, 20′ are arranged close to roller 10 in such a way, that the measuring device 20′ directly determines the thickness of the liquid layer 12 following the application of the oil film to roller 10 by delivery device 55 with the metering and donor rollers 50 and 60, while the second measuring device 20 determines the thickness of the liquid layer 12 after roller 10 has applied and set the toner material (not shown) on stock 5. Normally another roller is arranged below stock 5 to provide a counteracting force to the compressive force of roller 10, but this was not done in this case. This process is based on the idea that by the measurement of the two known thicknesses and with the knowledge of the circumference of roller 10 before and after the stock 5, it can be determined what the thickness of the liquid layer 13 on the stock 5 is after the setting and application on roller 10. The thickness of the liquid layer 12 or the oil film following the passing over of roller 10 over the stock 5, which is determined with the measuring device 20 and the computer-control unit 40, is equal to the thickness of the liquid layer 12 or the oil film prior to the passing of roller 10 over the stock 5, i.e., directly following the application of the liquid layer 12, together with the thickness of the oil layer 13, which is transferred during the setting process of roller 10 for setting the stock 5.

The thicknesses of the oil layer 12 calculated are transferred via the lines of the computer-control unit 40 as illustrated in FIG. 3, and by the comparison of the stored values to the values calculated, as described above, the desired quantity and the thickness of the liquid layer 13 on the stock 5 is determined. If this quantity is within a specified tolerance range, the delivery device 55 is operated unchanged. If the value is outside the tolerance range, however, the computer-control unit 40 controls the delivery device 55 in such a way that a decreased or increased amount of liquid or oil is dispensed by the delivery device 55.

Furthermore, roller 10 in FIG. 3 is provided with a rotary encoder 30, which can be used to precisely determine the rotational angle of roller 10. The rotary encoder 30 is connected with the computer-control unit 40. The measurement of the distance between the measuring transducers of the measuring devices 20, 20′ and the surface of roller 10 is carried out in certain short intervals. With the help of the rotary encoder 30, the measuring devices 20, 20′ can allocate the above-mentioned distances of the specified rotational angles, which are allocated to the corresponding positions determined on the surface of roller 10. This is advantageous, since, in this manner, the unevenness of the roller surface during measurements and calculations can be taken into consideration. Without the allocation of rotational angles at specified positions on the surface of roller 10, the measurements are independent of the measured positions on the surface, i.e., unevenness in the range of micrometers and nanometers of the configuration of the roller surface are included in the measurements and degrade the measurement results.

With the use of the rotary encoder 30, the measurements of unevenness on the surface of roller 10 are not affected, since the distances and the thicknesses of the oil layer 12 are measured by the respective measuring devices 20, 20′ at each of the same positions on roller 10. For example, in FIG. 3, this means that the two values measured in the previously determined moment by the measuring devices 20, 20′ at positions C and D are not compared and no calculation is performed with these two values. Rather, the two values measured at positions C and D are transferred to the computer-control unit 40, and the position D indicated by the cross drawn, whose value was calculated by measuring device 20′, is compared with the value that was calculated at the same position D on roller 10 by the other measuring device 20, after roller 10 has moved to the rotational angle α in the direction of the arrow. Accordingly, the line segment on the surface of roller 10 between C and D is allocated to the rotational angle α in order to identify the position D in the computer-control unit 40 in a clear manner.

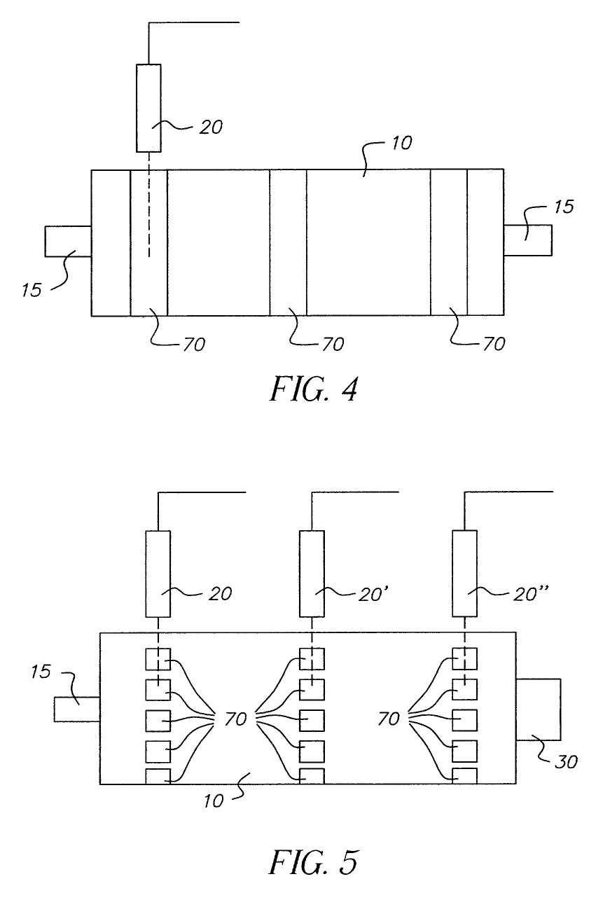

FIG. 4 shows a side view of a roller 10 with a shaft 15 and allocated measuring locations 70 in the form of strips on the roller surface. A measuring device 20 is allocated to the measuring locations 70, whereby the measurements are carried out at the measuring locations 70. The measuring device 20 is illustrated with a portion of its connection to the computer-control unit 40. The measuring locations 70 have a smooth surface that reflects the signals of the measuring device 20. The direction of a signal process of the measuring device 20 is illustrated in an exemplary fashion with a thin dotted line. The use of the measuring locations 70 is particularly advantageous, since the surface of setting rollers often does not have the required prerequisites for sensor measurements concerning smoothness and reflecting capacity. Accordingly, a higher measurement sensitivity is achieved in this manner.

It was discovered that the use of optical sensors as a component of the measuring device 20 required an especially smooth surface of roller 10 that had reflection capability, since with optical rays hitting rough and poorly reflecting surfaces, their reflections experience path deviations. The measuring locations 70 may be produced by the vaporization of thin metallic layers. It must be ensured that the measuring locations 70 adhere sufficiently to the roller surface and that they are sufficiently malleable, abrasion-resistant and temperature-resistant.

The measuring locations 70 are as small as possible in order to preserve the surface characteristics of roller 10 with respect to setting regarding oil absorption and sheet removal. The minimal width of the measuring locations 70 is equal to the ray cross-section of the sensor signal of the measuring device 20. It is understood that the measuring locations 70 in FIG. 4 are shown considerably enlarged in comparison to roller 10. With the embodiment according to FIG. 4 the oil film thickness is measured with the optical electronic sensors. Particularly with insufficiently smooth surfaces of the roller 10 or the measuring locations 70, the use of radiation in the infrared spectrum has proved to be useful. The measuring procedure corresponds to that described above.

With a further development according to FIG. 5, the measuring locations 70 are configured as rectangles. In this case, the measurements of the distances are only carried out with rectangles. This requires rotary control of roller 10, which ensures that the sensor signals of the measuring devices 20, 20′, 20″, which are shown here with lines to the signal transfer to the computer-control unit 40, are sent at the desired time. Rotary control is produced by the rotary encoder 30, which determines the rotational angle of roller 10 with the appropriate sensitivity and transfers it to the computer-control unit 40.

When a given rotational angle is present that has been allocated to a position on the roller surface on which a rectangle is located, the computer-control unit 40 transmits a trigger signal to the measuring devices 20, 20′, 20″, which triggers a sensor signal. The measurement is then carried out as described. In a variation, the described procedure can be also be used to determine and to control the oil layer thickness on metering or donor rollers 50 and 60 in a similar manner. In a modification, the procedure can further be used to determine and control the oil layer thickness on the metering and donor rollers 50 and 60. Further applications of the invention are, for example, the measurement and control of the thickness of a color layer or a moisturizing layer in a printer of a printing press.

The invention has been described in detail with particular reference to certain preferred embodiments thereof, but it will be understood that variations and modifications can be effected within the spirit and scope of the invention.

What is claimed is:

1. Procedure for measuring the thickness of a liquid layer (12) on a roller (10) of a printing press, with the procedural step of measuring the thickness of the liquid layer (12) in the printing press by a measuring device (20, 20′, 20″).

2. Procedure for measuring the thickness of a liquid layer (12) according to claim 1, with the procedural step of controlling a delivery device (55) for liquid based on the thickness measured.

3. Procedure for measuring the thickness of a liquid layer (12) according to claim 1, characterized by the procedural step of measuring the thickness of the liquid layer (12) at various positions of the roller (10) and storing of the measuring results in a computer (41).

4. Procedure for measuring the thickness of a liquid layer (12) according to claim 1, characterized by the procedural step of measuring the rotational angle of the roller (10) by a rotary encoder (30) and allocation of the rotational angle measured at a specified position on the roller surface.

5. Device for measuring the thickness of a liquid layer (12) on a roller 10 of a printing press, characterized by at least one measuring device (20, 20′, 20″), said at least one measuring device (20, 20′, 20″) being allocated to the printing press for measuring the thickness of a liquid layer (12).

6. Device for measuring the thickness of a liquid layer (12) on a roller (10) of a printing press according to claim 5, characterized by a computer (41) for calculating and storing of measured values of said at least one measuring device (20, 20′, 20″).

7. Device for measuring the thickness of a liquid layer (12) on a roller (10) of a printing press according to claim 5, characterized by a control unit (42) for controlling a delivery device (55) for rate of delivery of liquid to a roller based on the measured thickness of the liquid layer (12).

8. Device for measuring the thickness of a liquid layer (12) on a roller (10) of a printing press according to claim 5, characterized by several measuring devices (20, 20′, 20″) arranged at various positions of the roller (10).

9. Device for measuring the thickness of a liquid layer (12) on a roller (10) according to claim 7, characterized by a rotary encoder (30) for determining rotational angles of the roller (10).

10. Device for measuring the thickness of a liquid layer (12) on a roller (10) according to claim 5, characterized in that the roller (10) is heated and is a component of a setting device for setting toner on a stock (5).

11. Device for measuring the thickness of a liquid layer (12) on a roller (10) according to claim 7, characterized in that the delivery device is a metering and/or donor roller (50, 60) for transferring liquid to a setting roller.

12. Device for measuring the thickness of a liquid layer (12) on a roller (10) according to claim 5 characterized by said roller having specified measuring locations (70) on the roller (10).

13. Device for measuring the thickness of a liquid layer (12) on a roller (10) according to claim 12, characterized in that said specified measuring locations (70) contain at least one small strip extending around the circumference of the roller (10).

14. Device for measuring the thickness of a liquid layer (12) on a roller (10) according to claim 13, characterized in that said specified measuring locations (70) for determining the thickness of the liquid layer (12) contain individual rectangular areas determined as a function of the corresponding rotational angles of the roller (10).

15. Device for measuring the thickness of a liquid layer (12) on a roller (10) according to claim 5, characterized in that said measuring device (20, 20′, 20″) contains at least one interferometer.

16. Device for measuring the thickness of a liquid layer (12) on a roller (10) according to claim 5, characterized in that said measuring device (20, 20′, 20″) contains at least one reflectomer.

17. Device for measuring the thickness of a liquid layer (12) on a roller (10) according to claim 5, characterized in that said measuring device (20, 20′, 20″), particularly where a rough surface of the roller (10) is concerned, contains a device that uses radiation in the infrared spectrum, in particular an infrared sensor.
